(19) United States
(12) Patent Application Publication
(10) Pub. No.: US 2017/0167468 A1
(43) Pub. Date: Jun. 15, 2017

(54) SYSTEM FOR HYDROKINETIC ENERGY CONVERSION OF A FLUID CURRENT

(71) Applicant: Corporacion Andina De Fomento, Altamira (VE)

(72) Inventors: Jose TORAN, Distrito Capital (VE); Alvaro ATILANO, Miranda (VE)

(21) Appl. No.: 15/375,933

(22) Filed: Dec. 12, 2016

Related U.S. Application Data
(60) Provisional application No. 62/266,272, filed on Dec. 11, 2015.

(51) Int. Cl. F03B 17/06; H02K 7/18; F03B 13/00

(52) U.S. Cl. CPC F03B 17/06; F03B 13/00; H02K 7/1853

(57) ABSTRACT

A system for hydrokinetic energy conversion of a fluid current is disclosed. The system includes at least two floating platforms, each floating platform has a movable paddle that moves up to an elevated position and moves down to a low position. A transmission mechanism is included to operatively couple floating platforms to a power generator, so that, when in operation, alternatively, a first floating platform, having the movable paddle in low position, is dragged downstream of the fluid current causes the power generator to produce energy and further causes a second floating platform, having the movable paddle in elevated position, be pulled upstream.

### CROSS REFERENCE TO RELATED APPLICATION

This application claims the benefit of priority of U.S. Provisional Patent Application No. 62/266,272, filed on Dec. 11, 2015, the contents of which is incorporated herein in its entirety by reference.

### FIELD

The present invention relates to a modular device driven by fluid currents to generate back and forth linear movement of elements with the objective of generate mechanical or electrical power.

### BACKGROUND

The development and marketing of hydrokinetic renewable energy technologies of low (5 kW) and medium (250 kW) power to provide energy to communities of isolated rural areas near navigable rivers in basins around the world, such as the West Amazon basin and others mostly in Africa and Asia, is a short-term priority. Governments are interested in improving the quality of life of people settled down in these regions and in reducing efforts to provide energy to these areas. In these communities, electric power is mainly provided by small diesel generators that are costly to operate (diesel must be transported hundreds of kilometers through boats).

Given the geographic, ecologic, and climate characteristics, as well as the difficult access, areas such as the central part of the West Amazon basin and the like have few economically feasible alternatives to bring electricity to their communities. An alternative commonly used is the conventional network extension, however this may not be feasible in these areas not only because of their distances, but also due to the density of the tropical forest, and how inaccessible and dispersed the communities are.

This alternative may be feasible in communities that are relatively close to cities. Regarding part of the West Amazon, electricity has already been provided through the extension of the network from diesel generation isolated systems, located primarily in the provincial and municipal capitals.

Hydrokinetic energy conversion systems from river currents have been implemented since ancient times. The development of hydrokinetic energy converters for high-flow rivers, but with very low hydraulic or water heads and low speed currents, is in its beginning stages. There are very few technologies available on the market, currently only two: a) Garman axial flow-type turbines; and b) Darrieus cross flow vertical axis turbines. The available Garman turbines have a very low capacity (1 to 2 kW), but greater capacity Darrieus-type turbines can be found in the market (5 to 25 kW). Both types of turbines need a minimum speed of 1.5 m/s to work effectively, and this would limit its use in a great number of the rivers considered in the central area of the West Amazon basin, where the average speed of the flow of water is between 0.9 to 1.3 m/s. Both types of turbines would also be exposed to the risk of being hit by floating material (trees, branches, roots, animals, etc.), which is very common in the Amazon rivers and other tropical river basins.

Therefore, there is a need for the development of a technological solution oriented to work effectively (i.e., generate electricity affordably) especially in areas like rivers with the limitations and characteristics mentioned above. It would also be desirable that the new solution should be modular and scalable. In particular, the solution should be capable of obtaining hydrokinetic energy considering speeds of river flows ranging between 0.9 to 1.5 m/s. The solution should be designed for at least 500 W of power. The solution should also consider risks of being impacted with floating material (trees, branches, roots, animals, etc.), which are very common in navigable rivers, especially in basins such as the Amazon Basin.

### SUMMARY

It is a main goal of the present invention to use hydrokinetic energy of a fluid (e.g. water) current source in order to transform it into mechanical or electrical power.

It is an object of the present invention to allow easy placement of the device on any spot of a water channel, mainly rivers, depending on the characteristics of such channel, especially due to seasonal changes in flow, water level, sediments or any other reason associated to improve device performance, safety, or convenience, without requiring any major civil foundations or construction. It is also an objective of this invention to operate in a reliable way in remote areas with no human attendance during operation and minimal maintenance intervention.

It is another object of the present invention to provide a resistant structure and mechanisms to survive for collisions with elements being dragged by the water current.

It is another object of the present invention to be easily transported long distances by any means, especially when being towed or shipped by any small or medium size river crafts.

It is an objective of the present invention to provide a device that can be easily adjusted to operate at a fixed spot in the channel or river with variations of depth level due to sediments and seasonal tides.

It is another objective of this invention to provide different arrays of floating platforms that can be combined in different arrangements in order to achieve objectives like output power increment, output power uniformity, maximize benefit of water source conditions and adaptations to changes on the water source channel.

It is further object of the present invention a modular system to easily increase or reduce power generation according to the energy demand. It is also an objective to scale the size of the elements depending on the flow or demand conditions.

Yet another object of the present invention is to provide an easy to maintain system adapted to operate in remote areas far from technical service providers or spare parts suppliers.

To achieve at least some of the above objects, the present disclosure proposes a system for hydrokinetic energy conversion of a fluid current. The system includes two or more floating platforms including one or more movable paddles that move up to an elevated position out of the water and move down to a low position into the water. A transmission mechanism included in the system is responsible of transmitting tension and connecting each floating platform to a power generator, so that, when in operation, alternatively, a first floating platform with the movable paddles in low position is dragged downstream of the fluid current and causes the generator to produce electricity and a second floating platform with the movable paddles in elevated position be pulled upstream. A cycle can be thus defined and repeated.

The system is modular. More floating platforms or more paddles in each platform may be added to the system according to the energy demand, environmental requirement, etc.

In an embodiment with two floating platforms with paddles, the system works as follows. One of the floating platform has all its paddles completely submerged on the current, being moved downstream by the current, while the other floating platform has all its paddles completely out of the water therefore not affected by the current, and being pulled upstream by any mechanical transmission element (rope, line or equivalent) moved by the first floating platform. Once the floating platform with all its paddles completely submerged reaches a certain point, all its paddles are raise from the water by mechanical means at the same time that the paddles of the floating platform with all its paddles completely out of the water therefore not affected by the current, are lowered on the water for the current to affect them. These sequential movements of paddles of one floating platform being move out of the water while the paddles of the other floating platform being put into the water makes the first floating platform to be pulled upstream while the second floating platform being dragged downstream.

The cycle described above may be repeated as long as the system is working and can be stopped when all the paddles of each floating platform are out of the water at the same time (preferably) or in the water at the same time.

As explained above, floating platforms have relative back and forth movement with respect to a fixed structure that provides them guidance. The hydrokinetic energy of a water source, especially low speed currents ones, can be converted into mechanical movement of the floating platforms with moveable paddles. The floating platforms with paddles describe an alternative linear motion downstream (forth) and upstream (back), depending upon which floating platform has all its paddles submerged into the current, being moved by effect of the drag force of the current acting on its facing surface, or when floating platform has all its paddles out of the water being pulled upstream by means of a mechanical transmission element, driven by other floating platform with paddle submerged which is being moved downstream at the same specific moment. The linear movement of the floating platforms with paddles may be then converted into mechanical rotation of a shaft, in order to drive a mechanical device or an electrical generator.

The power generated by this upstream and downstream movement of the floating platforms is then transmitted to a main shaft via pulleys, wheels or the like, making this main shaft to rotate back and forth. This shaft transmits these back and forth movement to a gear box or an equivalent element in order to convert the back and forth rotating movement to a rotating movement in a single direction. By doing so, this single rotating direction movement can be coupled to an auxiliary shaft of a generator (e.g. a mechanical or electrical device). The present invention is capable of repeat cycles of alternative back and forth movements while converting the linear movement of the floating platforms with paddles.

All the mechanical transmission elements are preferably located outside of the water in order to minimize failures due to collision or jams with debris or elements being dragged by the water current, as well as to minimize maintenance because of corrosion and lack of lubrication.

### BRIEF DESCRIPTION OF THE DRAWINGS

FIG. 1 is a general top view of the first embodiment of two floating platforms with paddles during operation.

FIG. 2 is a general upstream view of the first embodiment of two floating platforms with paddles during operation.

FIG. 3 is a general side view of the first embodiment of two floating platforms with paddles during operation.

FIG. 4 is another general side view of the first embodiment of two floating platforms with paddles in operation during the beginning of a new stroke cycle.

FIG. 5 is yet another general side view of the first embodiment of two floating platforms with paddles in operation during the end of a stroke cycle.

### DETAILED DESCRIPTION OF THE INVENTION

The following figures are not to scale. The actual dimension and/or shape of each of the device components may vary. Only important details of the device are shown, however one of ordinary skill in the art can appreciate how the overall device may be constructed, without undue experimentation. As the main function of the device relates to transforming the drag force exerted by a water flow on submerged paddles mounted in floating platforms, it is theoretically well known that such dragging force is proportional to geometrical elements of the paddle (dragging coefficient and projected area perpendicular to the flow) and properties of the flow (speed and density), so certain small geometric or shape modification of the paddles with respect the shapes shown in these figures are considered in order to increase the dragging coefficient. Regarding the paddle size and number in each floating platform, as it is proportional to the drag force, it will depend on the desired level of power generation and the conditions of the water source where it will be placed.

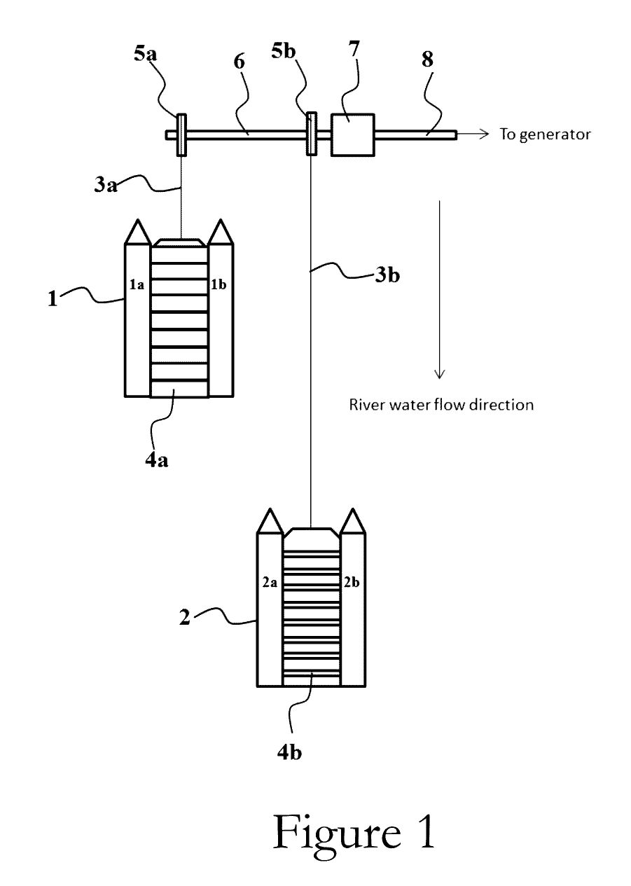

FIG. 1 is a general top view of the first embodiment of two modules with paddles during operation. The apparatus is composed by a floating platform 1 with float la and float lb (similar to a catamaran) and by floating platform 2 with float 2a and float 2b. Floating platform 1 is attached to a wheel or pulley 5a through line, cable or rope 3a. Floating platform 2 is attached to a wheel or pulley 5b through line, cable or rope 3b. Floating platform 1 contains on board a series of paddles 4a which in the present figure are out of the water. Floating platform 2 contains on board a series of paddles 4b which in the present figure are submerge in the water. Both wheels and pulleys 5a and 5b are attached to axis or shaft 6 which, by the movement back and forth of platforms 1 and 2, rotate back and forth. Shaft 6 is attached to gear box or equivalent apparatus 7 that has the purpose of converting the back and forth movement of shaft 6 in a rotating movement in only one direction that will be transmitted through shaft 8 to drive any mechanical device or electrical generator. Components 5a, 5b, 6, 7 and 8 are all in a fixed platform (with respect to the water movement or current of the river.

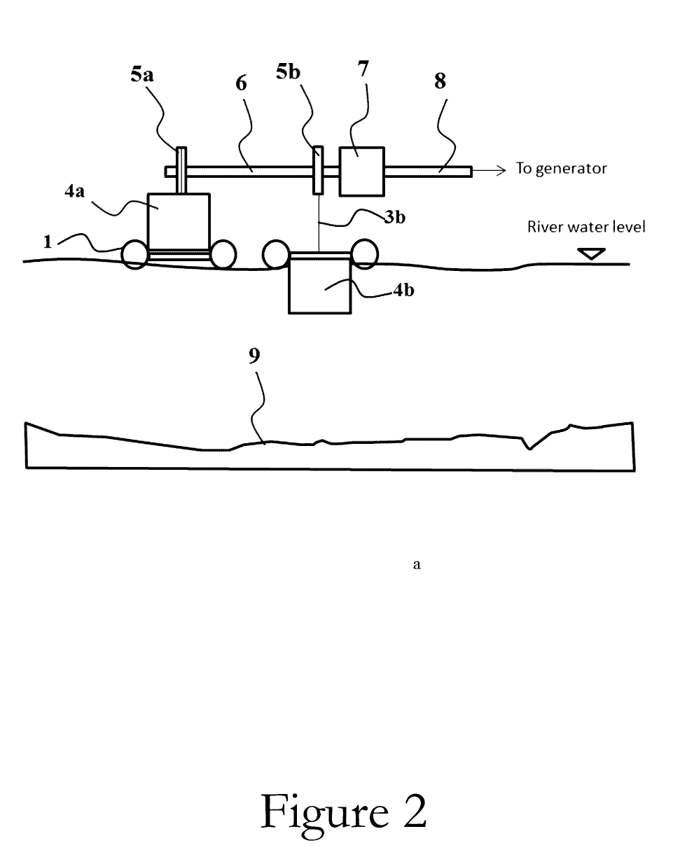

FIG. 2 is a general upstream view of the first embodiment of two modules with paddles during operation. As it can be seen from the figure, de paddles 4a of platform 1 are out of the river water therefore not being exposed to the drag force of the water current. Also, it can be seen that paddles 4b of the platform 2 are submerged in the river water and therefore exposed to the drag force of the water current. Under this arrangement, platform 1 is being pulled upstream by cable, line or rope 3a (not seen here) through the movement of wheel or pulley 5a and therefore is at the moment acting as the driven module (the driven stroke of the device). At the same time, floating platform 2 is being dragged downstream by the force of the water current on the submerge paddles 4b, transmitting the power to wheel or pulley 5b through cable, line or rope 3b, therefore is at the moment acting as the driving module (the driving stroke of the device). Also in the figure the bottom of the river or the river bed 9 can be seen, showing the device is floating at a certain water level.

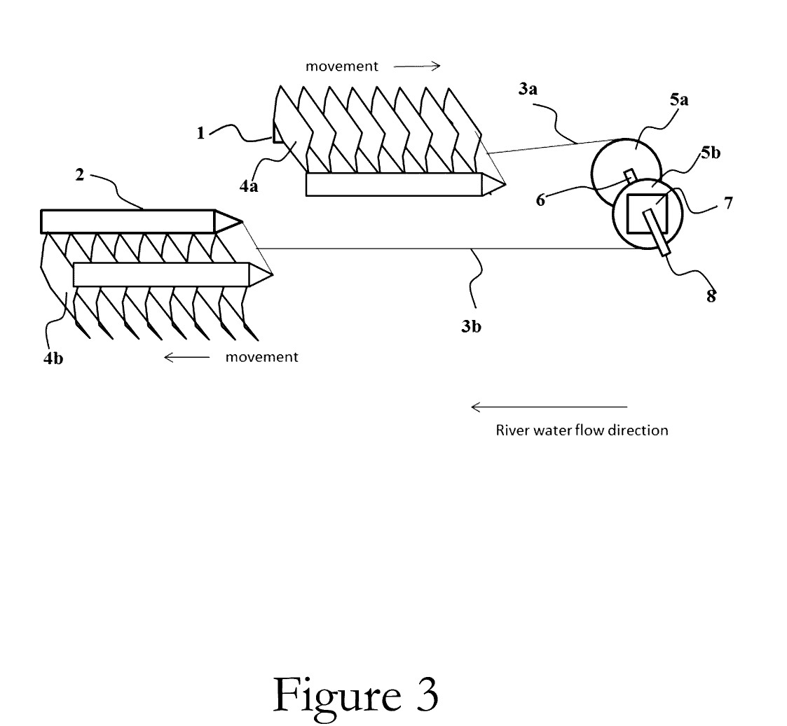

FIG. 3 is a general side view of the first embodiment of two modules with paddles during operation. In this figure it can be seen that floating platform 1 has all its paddles 4a out of the water resulting in the floating platform 1 moving upstream being pulled by line 3a through wheel or pulley 5a that is rotating clockwise in the figure (the driven stroke). Floating platform 2 has all its paddles 4a submerged in the water resulting in the floating platform 2 moving downstream being the paddles 4b dragged by the water current and pulling line 3b, which makes the wheel or pulley 5b rotate clockwise in the figure (the driven stroke).

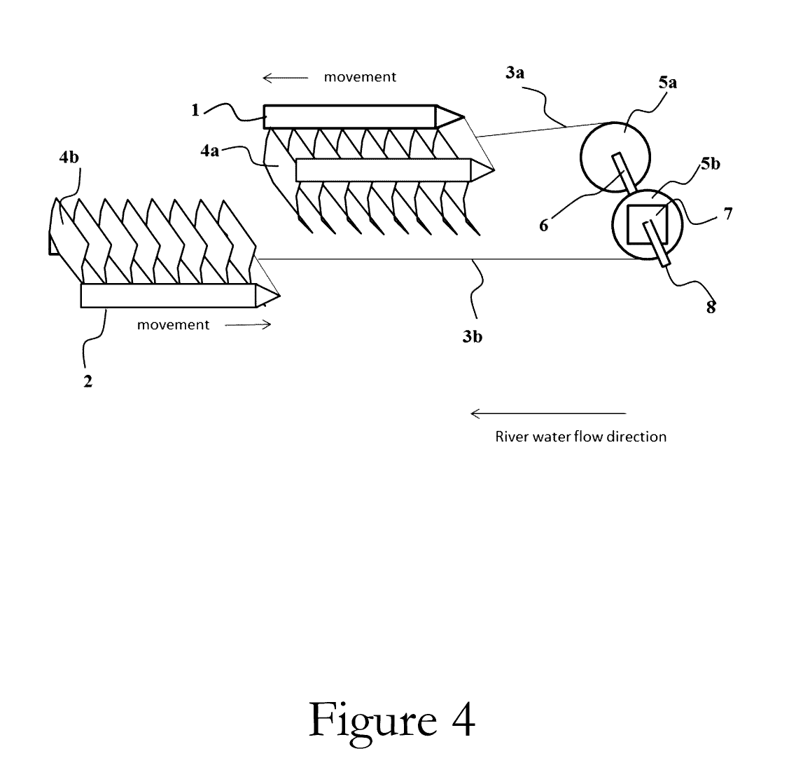

FIG. 4 is another general side view of the first embodiment of two modules with paddles in operation during the beginning of a new stroke cycle. FIG. 4 shows the moment in which a new cycle starts, where the paddles 4a of floating platform 1 are submerged into the river water, exposing them to the draft force of the water current and the movement of floating platform 1 is reverse (now going downstream), pulling wheel or pulley 5a through line 3a making it rotate counterclockwise in the figure (becoming the driven stroke). At the same time, the paddles 4b of floating platform 2 are raise out of the river water, ending their exposure to the draft force of the water current and the movement of floating platform 2 is reverse (now going upstream), being pulled by line 3b by the counterclockwise movement wheel or pulley 5b (becoming the driven stroke).

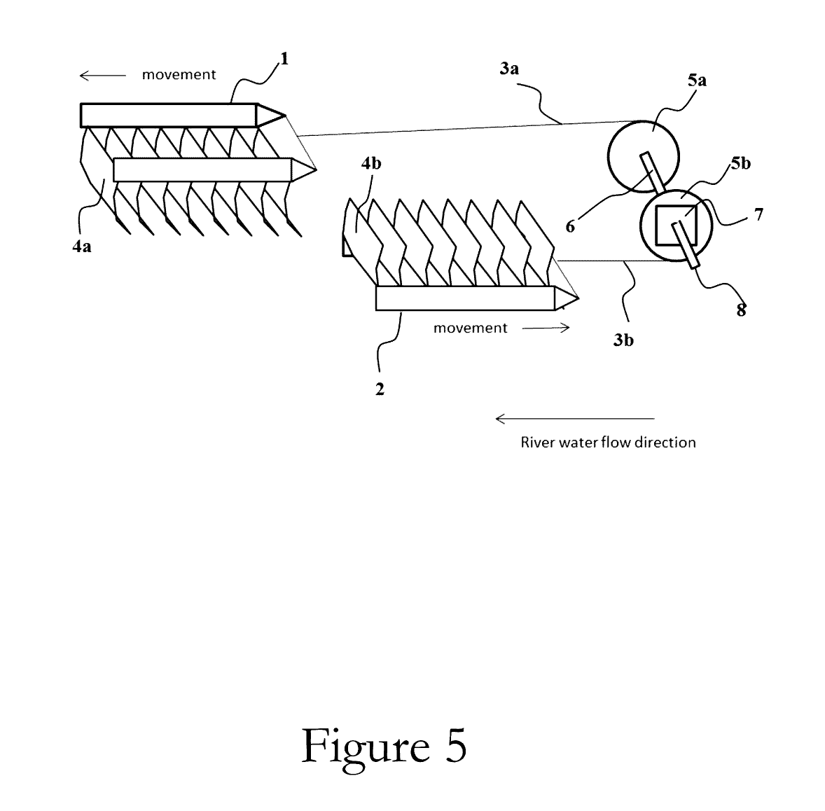

FIG. 5 is yet another general side view of the first embodiment of two modules with paddles in operation during the end of a stroke cycle. FIG. 5 shows the moment in which the new cycle discussed in FIG. 4 ends, where floating platform 1 with its submerged paddles reached the end (the farthest distance from the platform where the wheels 5a and 5b, main shaft 6 and auxiliary shaft 8 and gearbox 7 are located. At this moment, paddles 4a will be raised from the water and paddles 4b will be submerge in the water and a new cycle will begin.

The fixed elements can be placed in the platform, which besides of giving resistance and stability to the device, are in charge of keep floating the whole device, and provide guidance for the linear and swinging movements of the floating platforms with paddles.

The moveable elements are floating platforms with paddles, moving in opposed directions at any time, depending upon which floating platform has all its paddles submerged in the water or completely out of the water being at certain part of the cycle one of them the driving floating platform with paddles and the other the driven one, switching this function at the end of each stroke.

The movement of each paddle describes a cycle with four well defined stages, two linear displacement stages called strokes, and two transition stages which combine rotation and displacements. One of the strokes is called the driving stroke, it occurs when one of the floating platforms (the driving module) has all its paddles entirely submerged in the water and are affected by the current, in order to face the maximum surface perpendicular to the current direction, which makes it move downstream by dragging. During this stroke the driving module pulls on a rope, line or similar element that makes a wheel in a fixed platform rotate. The other stroke is called the driven stroke, and it occurs when the other floating platform (so called the driven module) has all its paddles entirely out of the water and the current of the water cannot affect them, in order to oppose minimal resistance when it moves upstream while being pulled by the transmission element. In both strokes floating platforms are restricted to move lineally parallel to the current, with defined start and end, in downstream (forth) and upstream (back) direction because of the guiding constraints located on the floating structure or platform that contains wheels, axis, gear box and shaft.

In order to ensure a continuous movement of the floating platforms with paddles once they reach the end of the stroke, it is provided a mechanism (an actuator or an mechanical arrangement) to pull the paddles out of the water in the so called driving module and, simultaneously, a mechanism to submerge all the paddles in the water in the so called the driven module. After these paddle movements are done, the driving module becomes the driven module and the driven module becomes the driving module.

The components of system for power generation through movement of fluid and its various components may be made from a wide variety of materials.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the embodiments disclosed and claimed herein can be made and executed without undue experimentation in light of the present disclosure. It will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A system for hydrokinetic energy conversion of a fluid current comprising:
at least two floating platforms, each floating platform comprising:
a movable paddle configured to move up to an elevated position and move down to a low position;
a transmission mechanism configured to operatively couple the at least two floating platforms to a power generator, so that, when in operation, alternatively, a first floating platform, having the movable paddle in low position, is dragged downstream of the fluid current causes the power generator to produce energy and further causes a second floating platform, having the movable paddle in elevated position, be pulled upstream.

2. The system according to claim 1, wherein the transmission mechanism comprises at least a main shaft, at least two pulleys coupled to the main shaft configured to rotate together and two connecting elements, each connecting element configured to transmit tension and to connect a floating platform to a pulley so that when rotating in a direction, one connecting element is wrapped and one connecting element is unwrapped around the pulley.

3. The system according to claim 2, wherein the transmission mechanism further comprising a gear box configured to engage the main shaft with an auxiliary shaft of a power generator.

4. The system according to claim 3, wherein, in operation, the transmission mechanism is out of the fluid current.

5. The system according to claim 1, wherein the floating platform further comprises a mechanical actuator for switching the position of the paddle.

6. The system according to claim 1, wherein the power generator is an electrical generator.

7. The system according to claim 1, wherein the power generator is a mechanical generator.

8. The system according to claim 1, wherein the paddle of the floating platform is replaceable.
